(19) United States
(12) Patent Application Publication
(10) Pub. No.: US 2020/0394587 A1
(43) Pub. Date: Dec. 17, 2020

(54) METHOD OF THREAT ASSESSMENT HAVING SCORECARD

(71) Applicant: APB Consulting Solutions LLC, Nicholasville, KY (US)

(72) Inventors: Scott A. O'Brien, Dry Ridge, KY (US); Todd M. Phillips, Lexington, KY (US)

(21) Appl. No.: 16/901,055

(22) Filed: Jun. 15, 2020

Related U.S. Application Data
(60) Provisional application No. 62/861,661, filed on Jun. 14, 2019.

(51) Int. Cl. G06Q 10/06; G06Q 30/00; G06Q 50/26; G06Q 10/10; G07C 9/29; G07C 9/22; H04N 7/18

(52) U.S. Cl. CPC G06Q 10/06393; G06Q 10/0635; G06Q 30/018; H04N 7/181; G06Q 10/105; G07C 9/29; G07C 9/22; G06Q 50/265

(57) ABSTRACT

A method of threat assessment includes the steps of (a) receiving data representative of a plurality of safety assessment categories and a plurality of threats within the plurality of safety assessment categories, (b) receiving data representative of at least one safety measure related to each of the plurality of threats; (c) analyzing the data with a safety assessment algorithm and (d) outputting a safety assessment scorecard indicating safety and security level of the facility.

### RELATED APPLICATION

This application claims priority to U.S. Provisional Patent Application Ser. No. 62/861,661, filed on Jun. 14, 2019, the contents of which are hereby incorporated by reference in its entirety.

### TECHNICAL FIELD

This document relates generally to safety and security at a public or private facility and, more particularly, to a new and improved method for enhancing the safety and security of that facility.

### BACKGROUND

Safety and security at public and private facilities is a critically important concern.

This document relates to a new and improved method of security assessment adapted to aid in identifying facility and organization/entity vulnerabilities which may, if not corrected, render the facility susceptible to criminal acts and/or violence. The perspective by which the assessment takes place is based on potentially malicious acts which exploit vulnerabilities effecting the members and visitors of the organization. The vulnerabilities addressed include, but are not necessarily limited to human health and safety, structural integrity for security and technological aids for securing a facility or building.

The purpose of a security assessment (also known as a security audit, security review, or network assessment), is to ensure that necessary security controls are integrated into the design and implementation of a facility or building. The facility security assessment will provide and outline security gaps within the structure and on the grounds. Management may address security gaps in three ways:
Management can request further analysis and explanation of an identified risk.
Allocate the necessary resources to correct the security gaps.
Accept the vulnerabilities and seek alternative risk solutions.

As the assessment is completed the following questions are asked: • Who/What needs to be protected? • What can be done to minimize the risk? • Who/What are the threats and vulnerabilities?.

### SUMMARY

In accordance with the benefits and advantages set forth herein, a new and improved method of threat assessment is provided. That method may be broadly described and comprising the steps of: (a) receiving data representative of a plurality of safety assessment categories and a plurality of threats within the plurality of safety assessment categories, (b) receiving data representative of at least one safety measure related to each of the plurality of threats, (c) analyzing the data with a safety assessment algorithm and (d) outputting a safety assessment scorecard indicating safety and security level of a facility.

In one or more of the many possible embodiments of the method, the method further includes the step of selecting the plurality of safety assessment categories from a group consisting of facility exterior, facility interior, safety protocols, training and combinations thereof.

In one or more of the many possible embodiments of the method, the method further includes the step of selecting the plurality of threats from a group consisting of exterior ingress/egress, exterior cameras, high speed avenue approach, light line, lobby/reception area, interior ingress/egress, interior cameras, VIP offices, offices, utility rooms, open room, employee identification, policy and procedure, reporting, mass communication and combinations thereof.

In one or more of the many possible embodiments of the method, the method further includes the step of selecting the at least one safety measure related to the exterior ingress/egress from a group consisting of number of ingress points, location of ingress points, exterior ingress/egress access control, presence of solid core doors, presence of glass in the doors, visibility of restriction for exterior ingress/egress access control from outside and combinations thereof.

In one or more of the many possible embodiments of the method, the method further includes the step of selecting the at least one safety measure related to the exterior cameras from a group consisting of live monitoring of exterior cameras, off-site live monitoring of exterior cameras, camera range to furthest active point, low light capabilities and combinations thereof.

In one or more of the many possible embodiments of the method, the method further includes the step of selecting the at least one safety measure related to the high speed avenue of approach from a group consisting of installed bollards, installed speed bumps, presence of structure barriers, presence of pedestrian barriers and combinations thereof.

In one or more of the many possible embodiments of the method, the at least one safety measure related to the light line is lighting extending beyond buildings on all sides by a predetermined distance.

In one or more of the many possible embodiments of the method, the method includes the step of selecting the at least one safety measure related to the lobby/reception area from a group consisting of installed hot box protocols, personnel present at lobby/reception desk, quick-lock protocols and combinations thereof.

In one or more of the many possible embodiments of the method, the at least one safety measure related to the interior ingress/egress consists of interior ingress/egress access control, stop gaps and visibility of restriction for interior ingress/egress control from outside.

In one or more of the many possible embodiments of the method, the method further includes the step of selecting the at least one safety measure related to the interior cameras from a group consisting of live monitoring of the interior cameras, including those located at ingress/egress points, off-site monitoring, utilizing an interior camera mirror layout and combinations thereof.

In one or more of the many possible embodiments of the method, the at least one safety measure related to the VIP offices includes a two-tier security level. Further, the at least one safety measure related to the offices includes access control to the offices, stop gaps, interior visual restrictions and solid core doors with minimal glass. In addition, the at least one safety measure related to the utility rooms includes access control to the utility rooms and the at least one safety measure related to the open room includes interior camera protocols for a mirror layout.

In one or more of the many possible embodiments of the method, the method further includes the step of selecting the at least one safety measure related to the employee identification from a group consisting of access control keycard, picture ID, two-sided ID, color coded ID and combinations thereof.

In one or more of the many possible embodiments of the method, the method further includes the step of selecting the at least one safety measure related to the policy and procedure from a group consisting of annual review process or incident review, termination/disciplinary meeting protocols, emergency planning and combinations thereof. In the method, the at least one safety measure related to the reporting, including threat reporting, after-action reporting, incident reporting and training reporting, may be analysis driven.

In one or more of the many possible embodiments of the method, the method further includes the step of selecting the at least one safety measure related to the mass communication from a group consisting of notification capabilities, GEO locator capability upon activation and combinations thereof.

In one or more of the many possible embodiments of the method, the method also includes the step of earning extra credit on the scorecard S for a factor selected from a group consisting of perimeter control, unarmed security, armed security, visitor identification, metal detector, mass lock/unlock capability, 24/7 camera monitoring, 24/7 roaming patrol, trained safety team, checkpoints, cyber security and combinations thereof. Still further, the method may also include the step of limiting establishment of any safety measure to an individual having a minimum of 20 years of law enforcement and/or military training or experience.

In the following description, there are shown and described several embodiments of the method of threat assessment. As it should be realized, the method is capable of other, different embodiments and its several details are capable of modification in various, obvious aspects all without departing from the method as set forth and described in the claims. Accordingly, the drawings and descriptions should be regarded as illustrative in nature rather than restrictive.

### BRIEF DESCRIPTION OF THE DRAWING FIGURES

The accompanying drawing figures incorporated herein and forming a part of this patent specification, illustrate several aspects of the method and together with the description serve to explain certain principles thereof.

FIG. 1 illustrates one possible embodiment of a safety assessment scorecard useful in the present method of threat assessment.

FIG. 2 is color coding system chart.

FIG. 3 illustrates an example of an area of focus, datapoints, rules for the datapoints and the percentage value of each rule.

FIG. 4 illustrates an example of the scorecard S after a completed first assessment.

FIG. 5A is a list of datapoints that may be used for the facility threat assessment.

FIG. 5B is a list of datapoints that may be used for evaluating infectious disease protocols and safety measures.

FIG. 6 is an example of the calculator.

FIG. 7 is an example of a SCORECARD BUILDING BLOCK used to determine threat levels for infectious disease safety measures.

Reference will now be made in detail to the present preferred embodiments of the method, examples of which are illustrated in the accompanying drawing figures.

### DETAILED DESCRIPTION

The method for threat assessment and enhancing the safety and security of a public or private facility disclosed herein focuses on the total security and safety footprint of an organization and ways in which those measures may be increased for protecting staff members, guests, and company assets.

Effective safety and security practices include:
Facility assessments
Training (classroom, roundtable, online instruction, and physical drills)
Developing information sharing skills
Policy and procedure design and review

The content of the report produced by the method includes:
Legal Disclaimer
Content Page
Introduction
Questions, Scope, and Purpose
Threats (based on facility assessment protocols)
Assessment Definitions
Assessment Code
Scorecard Description
Assessment Questionnaire
Facilities Assessment (including additional recommendations with definitions based on the safety and security needs of the facility)
Scorecard
Upgrade Recommendations—forecast
Recommended Best Practices.

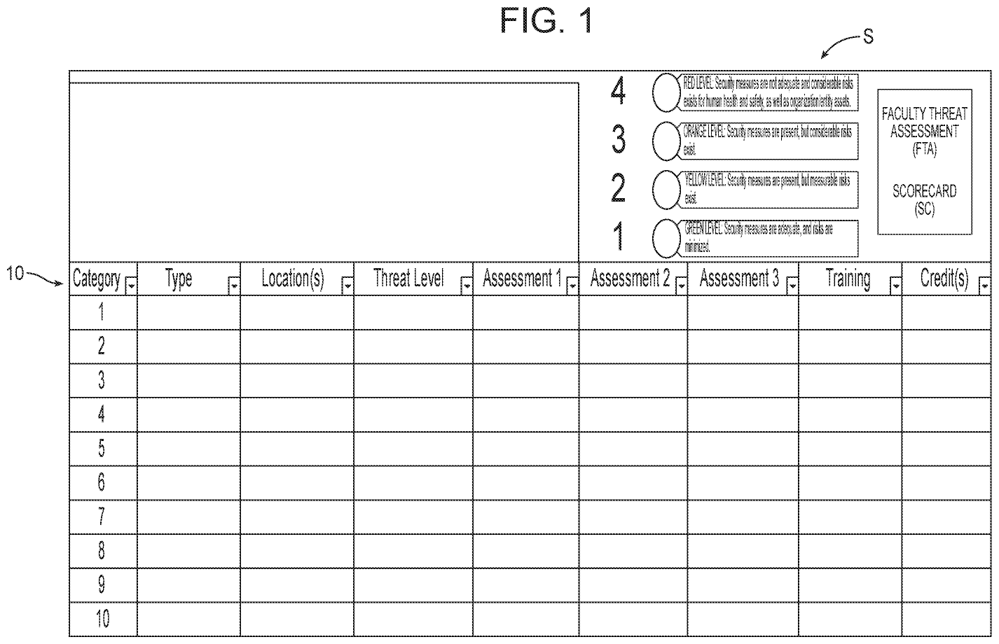

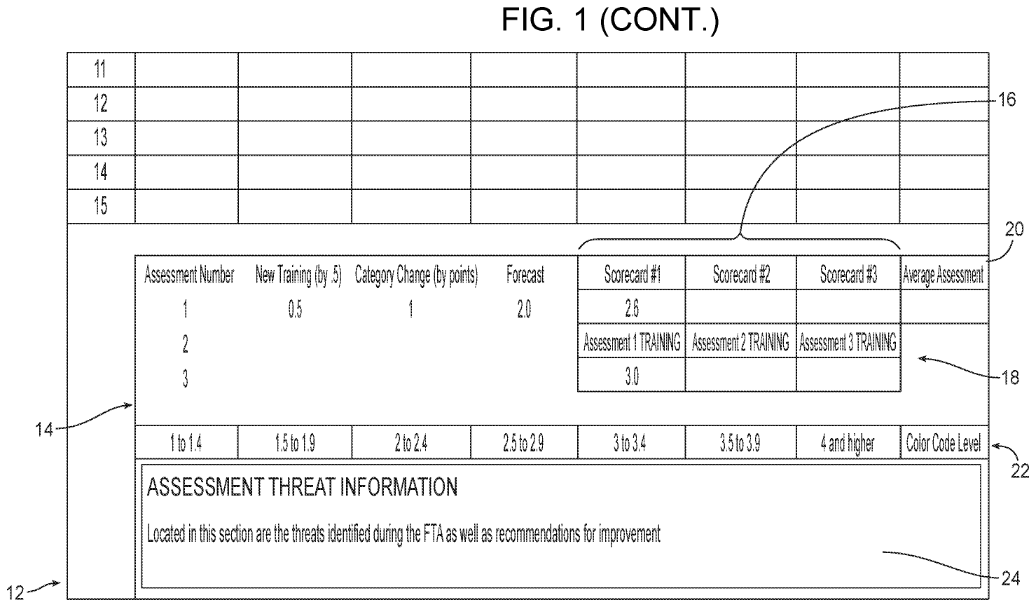

The method of threat assessment generally includes the steps of: (a) receiving data representative of a plurality of safety assessment categories and a plurality of threats within the plurality of safety assessment categories, (b) receiving data representative of at least one safety measure related to each of the plurality of threats, (c) analyzing the data with a safety assessment algorithm and (d) outputting a safety assessment scorecard S indicating safety and security level of a facility. One possible embodiment of that scorecard S is illustrated in FIG. 1.

The method may include the step of selecting the plurality of safety assessment categories from a group consisting of facility exterior, facility interior, safety protocols, training and combinations thereof. More specifically, facility exterior threats generally include building ingress/egress points, light lines, cameras, access control, wood lines, high speed avenues of approach, visual capabilities, doors, windows, roof access, neighboring structural threats, and potential neighboring business threats. Facility interior threats generally include ingress/egress, cameras, access control, sensitive rooms and property, hallways, open rooms, offices, VIP locations, locking devices, waiting rooms and lobbies, stairwells, utility rooms, emergency equipment waypoints locations, and visual capabilities. Safety protocol threats generally include personnel, policy and procedures, personnel identification, access control, cameras, volunteers, and reporting system(s), and training programs.

Training is a significant enough protocol that it must be categorized by itself directly effecting each line item of the scorecard S. Training threats generally include training topics, frequency of training, effectiveness, who is trained, instruction format, and records. The importance of training is reflected on the scorecard S encompassing 40% of the overall rating.

Threats can be direct or implied statements using audible or written messages indicating the intent to harm the organization, a group, or individuals. Vulnerability threats are parts of a physical structure, policy/procedures, or processes exposing the organization to potential safety and security liabilities. The following are definitions used in the facility threat assessment for providing an explanation of suspicious practices and criminal acts. These definitions provide a general overview of the types of potential actions which may be taken once vulnerabilities are discovered by an individual or group seeking to harm the entity.

SURVEILLANCE is conducted using the naked eye or technology for gaining information and intelligence on organizations, groups of people, or individuals. The fraudulent or unauthorized use of identification or access control as a means of entering a location is a form of surveillance.

SABOTAGE/TAMPERING are techniques which alter, disrupt, or damage the normal and safe operating procedure(s) of an object for the purpose of malice and destruction.

THEFT refers to the unauthorized removal of any object from the organization or employee.

CONTAMINATION/VANDALISM refers to the deliberate damage of an object for the purpose of defacement and/or destruction.

CYBER ATTACK refers to the attempt by hackers to damage or destroy a computer network or system.

The next set of definitions are used as descriptions for safety and security measures. This verbiage may be used within the facility threat assessment report to describe a vulnerability or a method of security upgrade.

HUMAN HEALTH AND SAFETY refers to reducing the risk of harm to an individual or group (the participants) based on location, security tools, and security protocols.

STRUCTURAL INTEGRITY FOR SECURITY refers to accessories such as doors, locks, frames, bollards, gates, lighting, and/or fencing.

TECHNOLOGICAL AIDS refers to accessories which enhance a structure such as cameras, access control, and access control software and any other technology identified as being used to enhance the safety and security of the participants.

HIGH SPEED AVENUE OF APPROACH refers to a path, road, or avenue by which a vehicle may accelerate and strike the organization/entity or any of its participants.

MIRROR LAYOUT is a strategic design for aligning closed-circuit cameras (either exterior or interior) in a crisscross pattern which monitor one another reducing blind spots for viewers.

INGRESS/EGRESS is the act of entering (ingress) a building and the use of an exit for going out (egress).

LIGHT LINE is the maximum distance a light extends around an object to create an illuminated parameter.

HOT BOX is a secured locked location at an entry point, that temporarily prevents ingress utilizing access control, a communication system, and cameras or communication window such as a reception window.

TWO-TIER SECURITY encompasses fortifying individuals, property, or records in a locked location within an additionally locked and secured environment. An example of this would be an internal locked office(s) within an ingress-controlled structure that can only be accessed through some additional form of ingress control. Additional examples would be a locked filing cabinet or safe located in a locked room or closet designated for sensitive material or property.

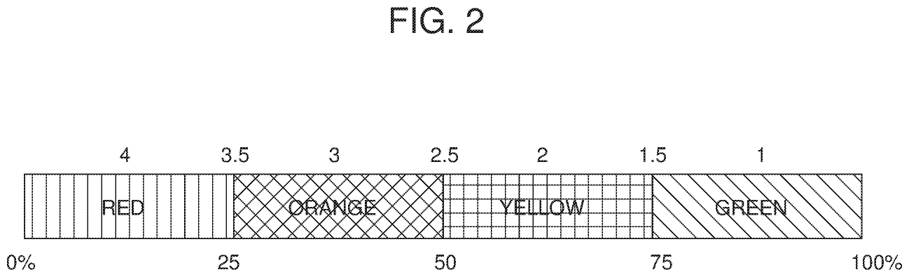

The color coding system illustrated in FIG. 2 identifies the level of threat severity to any given datapoint evaluated in the facility threat assessment, an area of focus (i.e. exterior, interior, or protocol), or the overall threat level of the entity. Included are the definitions for each threat level. Green represents the safest and lowest threat level up to red, which represents the most vulnerable or highest threat.

Level 1—GREEN LEVEL: Security measures are adequate, and risks are minimized.

Level 2—YELLOW LEVEL: Security measures are present, but measurable risks exist.

Level 3—ORANGE LEVEL: Security measures are present, but considerable risks exist.

Level 4—RED LEVEL: Security measures are not adequate and considerable risks exists for human health and safety, as well as organization/entity assets.

The threat levels for each area of focus are determined by the datapoints used in the facility threat assessment scorecard S. There are three main AREAS OF FOCUS for every facility threat assessment conducted; exterior, interior, and protocols. Each area is defined by a set of datapoints which are also included in the scorecard S. Based on the number each datapoint receives (explained later in this document), those points categorized under exterior rules, interior rules, and protocol rules will then be averaged and assigned a color on the facility threat assessment color coding system (i.e. the color coding system chart illustrated in FIG. 2).

Rules that are used in the facility threat assessment include, but are not necessarily limited to:

FTA Exterior Rules/Recommendations: A four-side layout for each physical structure is assessed (1—front, 2—left side, 3—rear, 4—right side) and specific structural threats or locations for recommended security upgrades are described. Illustrations include the placement of exterior cameras (including the visual capabilities), light lines, wood line control, high speed avenues of approach, bollard locations, neighboring businesses, and neighboring threat distances.

FTA Interior Rules/Recommendations: Analysis of threats affecting the interior of a facility include (ingress/egress, cameras, access control, sensitive rooms and property, hallways, open rooms, offices, VIP locations, locking devices, waiting rooms and lobbies, stairwells, utility rooms, emergency equipment waypoints. locations, stop gaps, and visual capabilities). Specific descriptions of problematic areas are provided through picture illustration and/or a description on the slide.

FTA Protocol Rules/Recommendations: Protocols are used for determining common or daily practices which may become a potential threat to the organization/entity and its participants. Included in the protocol analysis are policies surrounding personnel, safety procedures, personnel identification, access control, cameras, volunteers, and reporting system(s). In many cases improved protocol changes will impact the organizations safety and security more exponentially than other physical security upgrades.

The scorecard S helps demonstrate an organization's overall threat level based on a holistic approach of security. A low score reflects a lower threat level. Higher scores illustrate a higher threat level.

The scorecard S includes scores specific to individual datapoints detailed in the assessment. Those datapoints generally relate to security upgrades, policy and procedures, reporting and training. They may be weighted in the final assessment score as follows: security upgrades 16%, policy and procedures 17%, reporting 27% and training 40%.

Repetitive safety related training is a focal point during the assessment. Without training for each datapoint assessment, an organization/entity approach to the safety and security of human life is incomplete. Training is fundamental to the safety for all participants and assets involved in any organization/entity. The scorecard S is a “living document” meaning as each upgrade is implemented the score improves. The scorecard S tier range is 1 to 4; 1 being the lowest and safest level with 4 being the highest and most at risk threat level. Typically, instant improvements come by way of approved training (on-line or classroom) and protocol improvements.

The assessment code is one of the most important parts of the overall review. This coding system assigns colors based on a threat level. Color codes are the simplest form of awareness. Colors are used to articulate safety levels and warnings in nearly every aspect of society making the code simple and easy to understand for everyone. What is unique about the disclosed color coding system is it incorporates specific threat levels for each color. Each threat level is quantitatively measured using a mathematical formula to assist the assessor in identifying a color code the organization/entity should receive. Each color is assigned a number which will have a mathematical factor used by the assessor to generate an overall score for determining the organization's/entity's threat level.

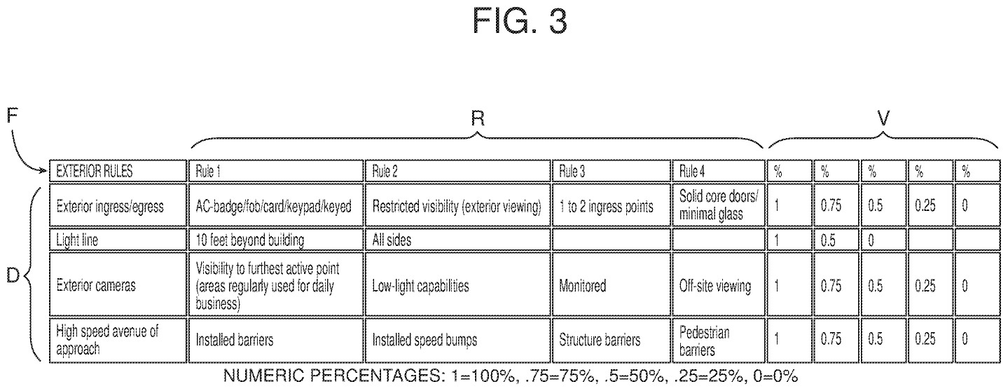

Like a golf score, the scorecard S is formatted from 1 to 4 (1 having the lowest tier threat level and 4 the highest tier threat level). Rules are assigned to each datapoint for every area of focus. Based on the number of rules followed at the time of the assessment, a percentage score is provided for that item. FIG. 3 illustrates an example of an area of focus F, datapoints D, rules for the datapoints R, and the percentage value of each rule V.

As an example, we will use a fictitious assessment for the EXTERIOR of “Building A”. Exterior Ingress/Egress: 2 of 4 rules met=0.5 or 50% Light Line: 1 of 2 rules met=0.5 or 50% Exterior Cameras: 1 of 4 rules met=0.25 or 25% High Speed Avenue of Approach: 0 of 4 rules met=0 or 0%. The sum percentages of the EXTERIOR are then compared to the color coding chart shown in FIG. 2 for determining a threat level number.

Once the threat level number is determined, it is assigned to the correlating datapoint for EXTERIOR RULES. That number is then compared to the color chart and assigned a color code.

| Exterior Ingress/Egress: 2 of 4 rules met = .5 or 50% | |
|---|---|
| 2.5 Light Line: 1 of 2 rules met = .5 or 50% | |
| 2.5 Exterior Cameras: 1 of 4 rules met = .25 or 25% | |
| 3.5 High Speed Avenue of Approach: 0 of 4 rules met = 0 or 0% | 4.0 |
| SCORECARD threat level for EXTERIOR (AVG.) | 3.1 |

The EXTERIOR threat is given a color of ORANGE (i.e. 3.1 falls between 2.5 and 3.5). The threat is defined as, “security measures are present, but considerable risks exist”. The color is then shown on the title slide for EXTERIOR.

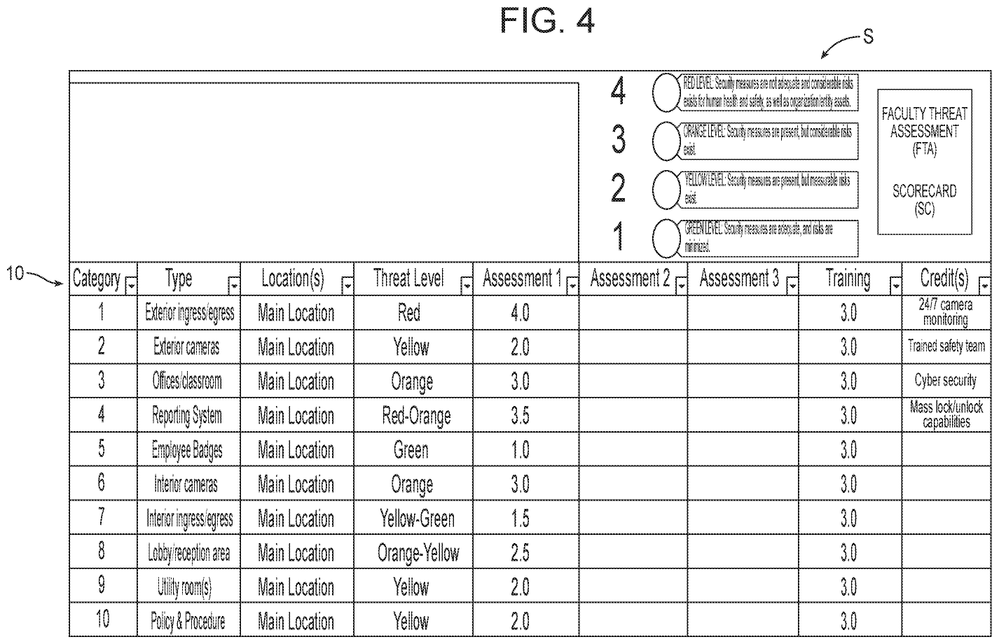

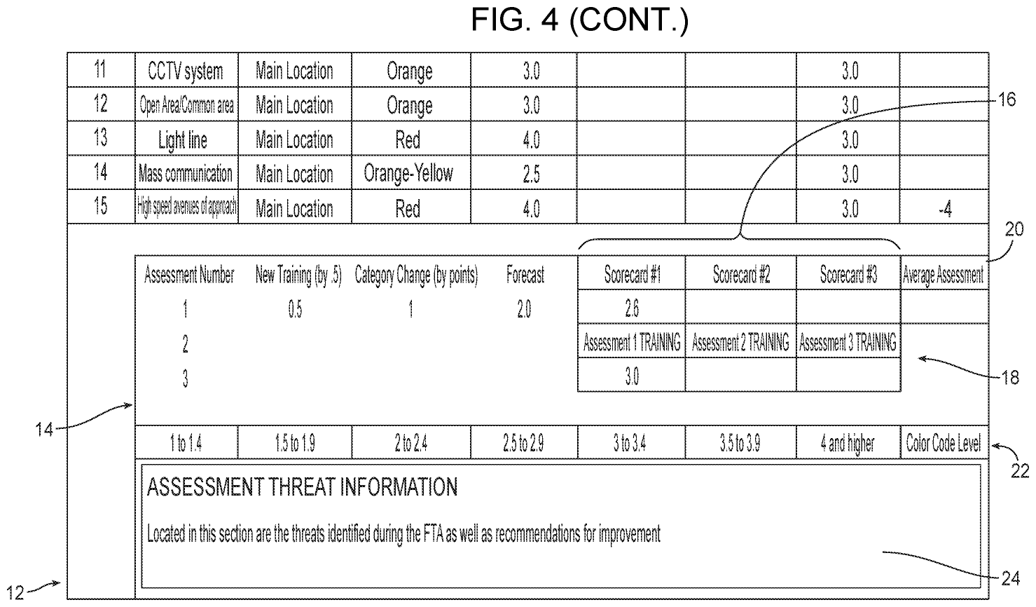

FIG. 4 illustrates an Example of the scorecard S after a completed first assessment.

The top portion or row 10 of the scorecard S is divided into CATEGORY (datapoints), TYPE, LOCATION, THREAT LEVEL, ASSESSMENT 1, ASSESSMENT 2, ASSESSMENT 3, TRAINING, and CREDIT(S).

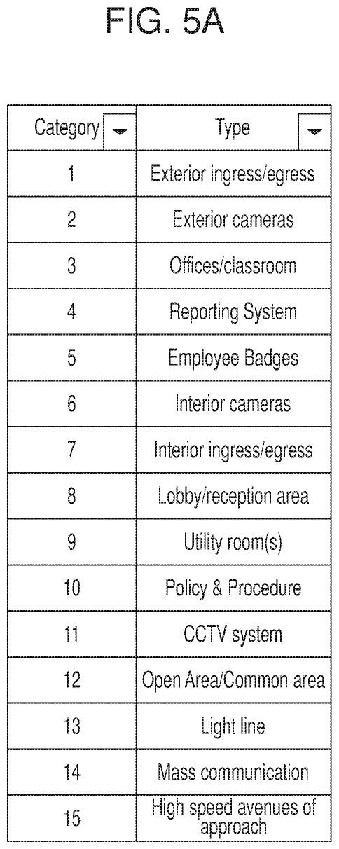

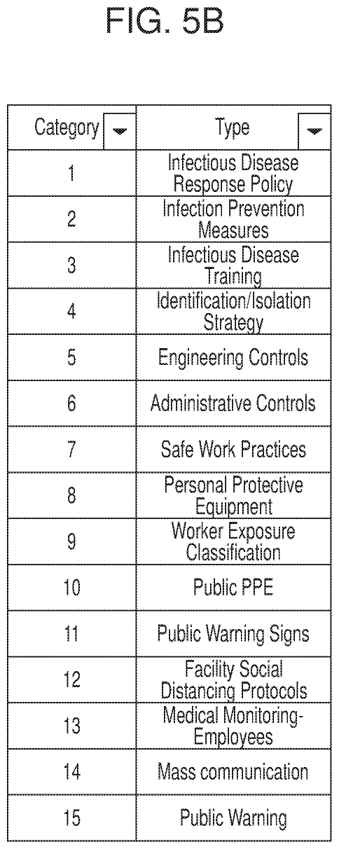

CATEGORY and TYPE reflect the datapoints which will be scored and provided a threat level. Advantageously, the design of the scorecard S allows for various types of datapoints to be used in the facility threat assessment process. For example, the datapoints 1-15 listed in FIG. 5A are used for the facility threat assessment. In contrast, the datapoints 1-15 listed in FIG. 5B are used for evaluating infectious disease protocols and safety measures. This allows for the scorecard S to be specific to goals and objectives of any entity for examining not only physical structures and procedures, but other factors which may play a role in effective safety and security measures. Any or all of these datapoints, as well as others of specific interest to the facility or organization may be used as desired. Based on the needs of the organization, multiple scorecards may be used to reflect the various items needing threat examinations.

LOCATION is simply describing the site assessed. The LOCATION will fall into one of two descriptions: main or satellite. The THREAT LEVEL is the color assigned to the specific datapoint based on the earlier mentioned formula (FIG. 2).

The ASSESSMENT 1 column is the first assessment completed for the entity. Numeric scores are listed to match the THREAT LEVEL color in the previous column. This allows for the reader to see both the color and number associated with the threat level derived from the facility threat assessment. ASSESSMENT 2 and ASSESSMENT 3 are follow up assessments that have the same guidelines/procedures. The THREAT LEVEL will always reflect the latest assessment completed (1, 2, or 3).

TRAINING is scored on a scale identical to the scorecard S, 4 is a high threat or poor rating while 1 is a low threat or excellent rating. At the beginning of each assessment, the organization will start with a 4.0 in the TRAINING column. Exceptions for a different starting score may be approved based upon courses or other designated trainings the organization completed prior to the first facility threat assessment (FTA). Each approved training course is given a value of (0.5). As an example, a company has no training upon completion of ASSESSMENT 1, receiving a score under TRAINING of 4.0. Between the first and second assessment the company completed one approved training. They will now receive a score of 3.5 in the TRAINING section at the completion of ASSESSMENT 2. Due to the heavy emphasis placed on training, every datapoint has a corresponding TRAINING score which is calculated into the final score for that assessment. CREDITS (or extra credit) are awarded based on specific items discovered in the FTA review which enhance safety and security measures. In the example to the right four credits have been awarded. CREDITS assist in lowering the overall score on the scorecard S. The lower portion 12 of the scorecard S illustrates the FORECAST 14, SCORECARD 1, 2, and 3 scores 16, ASSESSMENT TRAINING 1, 2, and 3 scores 18, the AVERAGE ASSESSMENT score 20, the COLOR CODE BAR 22, and ASSESSMENT THREAT INFORMATION 24.

The FORECAST section 14 is provided as a guide to understanding the next potential score based on the second assessment if all recommendations are met from ASSESSMENT 1. The three areas in the FORECAST shown are NEW TRAINING, CATEGORY CHANGE, and the FORECAST score. NEW TRAINING recommends how many training courses should be completed prior to the next assessment (0.5 for each course). CATEGORY CHANGE is the estimated change per datapoint in the FTA. For example, if a score of 3.5 was received in CATEGORY 1—TYPE Exterior Ingress/Egress on the first assessment, the anticipated change of score for the next assessment will be 2.5 if all recommendations are met. The change of 1 in the CATEGORY CHANGE is for every datapoint in the scorecard S. The FORECAST score is totaled by using the same process as the SCORECARD calculation (demonstrated later in this document) using the anticipated datapoint scores for the next assessment (i.e. 3.5—first score to 2.5—anticipated second score). SCORECARD 1, 2, and 3 are the scores for those assessments along with an AVERAGE ASSESSMENT from all three scores. ASSESSMENT 1, 2, and 3 TRAINING are the training course completed at the time of that FTA. The COLOR CODE BAR reflects the relationship between a color and numeric score. Threats and recommendations from the FTA are reiterated in the ASSESSMENT THREAT INFORMATION box to remind an organization of the needed upgrades for obtaining improved scores in future assessments. The final portion of the SCORECARD offers GENERAL BEST PRACTICES (not shown) for review as it pertains to overall security strategies.

The scorecard rules may only be defined and/or created by an individual, or group of individuals with no less than 20 years of law enforcement and/or military training. If an individual, or group of individuals has combined law enforcement and military experience, they shall have no less than 15 years of experience in law enforcement. The individual, or group of individuals shall also meet the below standards whether having done so in a single position that does each of the requirements, or through combined positions.

Training and experience not less than 10 years of investigating, prosecuting, and operational work against violent persons;

Training and experience with not less than 10 years of investigating, prosecuting, and operational work against gangs and organized crime;

Training and experience with not less than 2 years in intelligence analysis related to terrorism and mass gathering attacks, both foreign and domestic;

Training and experience not less than 2 years in intelligence analysis related to violence and criminal trends;

Not less than 10 years of advanced law enforcement and/or military tactics training and experience;

Training and experience with high level security systems and technology;

Not less than 10 years instructor level experience in training and implementing operational teams (law enforcement and/or military);

Not less than 10 years of supervision and/or field level covert operations experience (law enforcement and/or military);

Not less than 2 years of training and experience in course development and education pertaining to workplace violence, verbal de-escalation, and situational awareness; and

Not less than 10 years of training and experience in surveillance and counter-surveillance measures (law enforcement and/or military).

The RULES for all datapoints are ONLY determined by personnel meeting the above requirements. If SCORECARD evaluations are needed by an entity to include datapoints which fall outside the scope of personnel expertise, those datapoints and rules will be determined by an approved expert in that field of focus for using the SCORECARD process.

Below is an example of the BUILDING BLOCK for the Facility Threat Assessment CATEGORY RANKING, CATEGORY ORDER, AREAS OF FOCUS, TYPES/datapoint, RULES, and percentages. Each TYPE/datapoint then has a set of assigned RULES as shown in this application. No TYPE/datapoint has any more than four RULES or less than one RULE.
Considering that a TYPE/datapoint starts at 0%, each RULE met increases the goal to reach 100%. An example would be; if the TYPE/datapoint has two RULES, and only one RULE was met, then that TYPE/datapoints would be credited 50%.
Once percentages are assigned to each TYPE/datapoint the percentages are then added together for a total that is then divided by the number of TYPE/datapoint in that threat. The average percentage is then compared to the color code key and assigned a COLOR and CODE VALUE. Each threat will have its own COLOR and CODE VALUE. There will also be an overall score that is later defined.
TRAINING uses a similar mathematical formula. It is assumed that no training exists which is represented by the number “4.0”. As qualifying trainings are identified, a credit of 0.5 or half a point is subtracted from the starting number of 4.0. Only training created by individuals or groups that meet the definition shown in this algorithm qualify. Once a final number is identified, it is compared to the color code key and assigned a COLOR or CODE VALUE.
Each TYPE/datapoint percentage will be compared to the APB color code key and assigned a THREAT LEVEL. This will be done for all 15 TYPE/datapoints.
Extra credit can be earned for the overall score. There are 11 factors that have a value of one point each that can be used to earn extra credit.
For determining the score for the FTA (using the sample scorecard S below on ASSESSMENT 1) the blocks are added for a sum and then divided by the number 31 (15 TYPE/datapoints, 15 TRAINING scores, and CREDIT score). That final number considered the total is then compared to the color code key to identify the corresponding color and number for the final threat assessment.

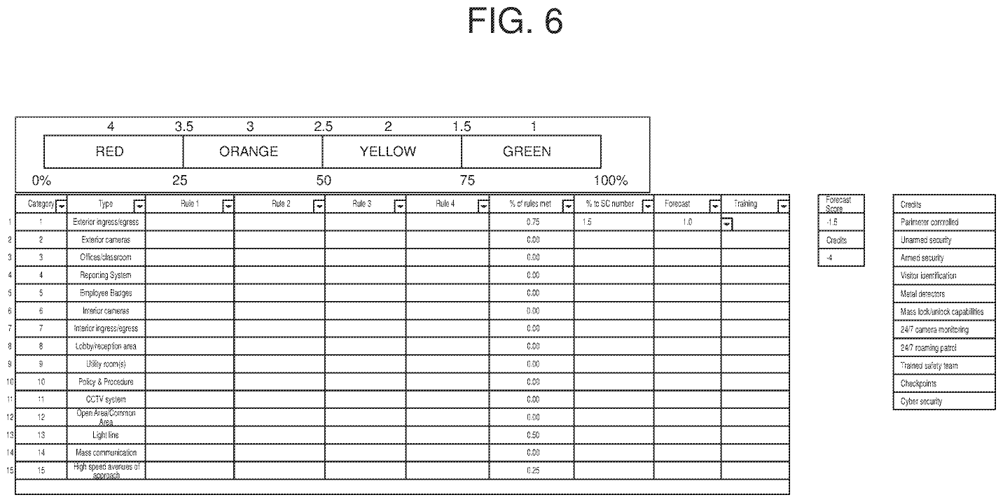

The FTA GUIDE for determining all datapoint scores which will be used in all Facility Threat Assessment reporting. The layout for the calculator is a similar layout to the actual scorecard S using the same mathematical formulas. FIG. 6 illustrates an example of the calculator.

As in the SCORECARD, CATEGORY, and TYPE/datapoint refer to the specific information being examined. RULES 1, 2, 3, 4 are the defined rules which must be associated with the datapoint to obtain a 100% or 1 or GREEN. Each block under the RULES 1, 2, 3, 4 once clicked by the analyst will show a drop-down box of the associated rule(s). If the rule is discovered to be present during the FTA the rule in the drop-down box will be clicked and appear in the box (dark grey boxes are not to be used—one to four rules may exist for each line item). This demonstrates the rule for that line item was present. Depending on the number of rules present will determine the percentage. Once the percentage is determined by comparison to the COLOR CODE BAR, the percentage is translated into the SCORECARD NUMBER (SC NUMBER). This column will be copied to the final scorecard S.

The FORECAST and TRAINING columns are completed based on the desired projections for the next assessment. For example, if the APB assessor recognizes a change of 1 point should take place in each line item of the scorecard S it will be illustrated in the FORECAST column (red box).

Likewise, for the TRAINING column based on the amount of training needed for the organization (0.5 is awarded for one approved training course). The FORECAST, TRAINING, and CREDIT(S) columns are added and divided by 31 (same process for the ASSESSMENT 1, 2, 3 scores) for obtaining the FORECAST score (illustration below).

CATEGORY RANKS for the FTA are determined by approved personnel who meet or exceed the requirements previously outlined. CATEGORY RULES for the FTA are as follows:

All TYPES/datapoints are important in the FTA process. RANK is determined based on analysis preventing serious physical injury and/or death to human life. If datapoints are needed for a SCORECARD outside the scope of personnel expertise, the RANK will be determined by an approved expert in the field of focus.

The SCORECARD CATEGORY AVERAGE section is utilized for breaking down individual TYPE/datapoints for scores to analyze low to high threats. This section is primarily used for GRAB (Global Resource Analytic Builder) facility threat assessments reporting when comparing multi-site locations within the same organization. Multiple scores from different building/facilities may be inputted into the top section for contrast.

The same process will apply to the lower section for the AREAS OF FOCUS listed under CATEGORY/TYPE. Each building score may be assessed and analyzed for developing a comprehensive plan for the entity's local, regional, national, or global safety and security footprint. The COLOR CODE BAR is used in the same format as previously described.

All drop down boxes within the scorecard S are stored in the section marked DATAPOINTS. If additional data is needed for a scorecard S, the information will be placed in a column with a heading classifying its location on the scorecard S. Using a data validation feature, the information will appear once a specific block is clicked in the scorecard S.

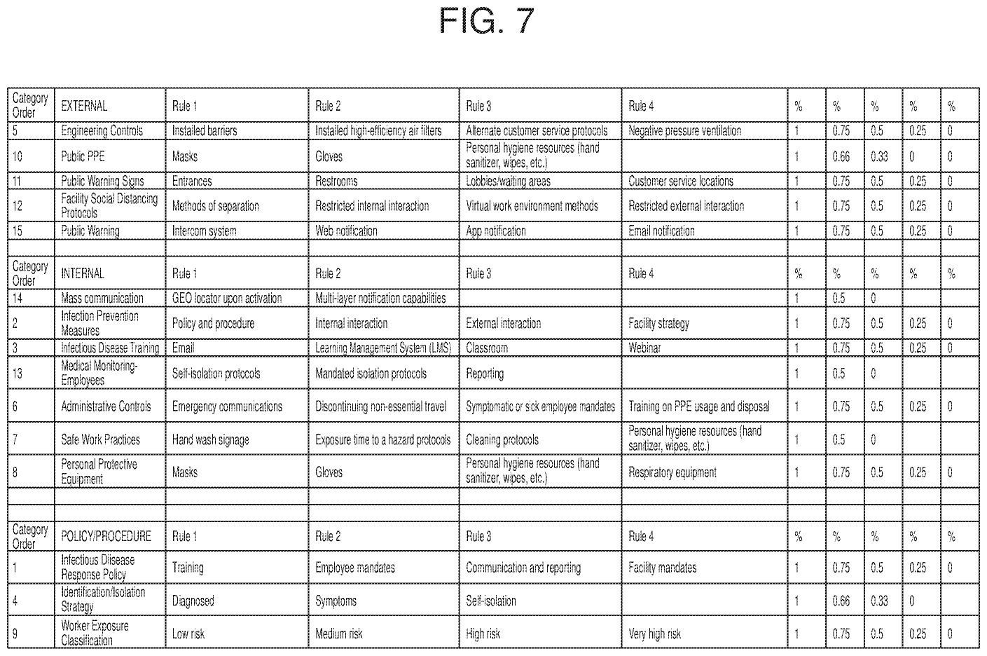

As mentioned above, the scorecard S is designed for information collection on other areas deemed significant and in conjunction with the original facility threat assessment scorecard S. FIG. 7 is an example of a SCORECARD BUILDING BLOCK used to determine threat levels for infectious disease safety measures. The final scorecard S is identical to the one for the FTA facility threat assessment shown in FIG. 1, varying only in the areas of TYPE/datapoints and RULES.

The method of threat assessment, including the steps of receiving data, analyzing data and outputting a safety assessment scorecard may all be implemented using a computing device or controller comprising one or more processors, one or more memories and one or more network interfaces all in communication with each other over one or more communication buses. Such computing device or controller may be a dedicated microprocessor with hardware control or may operate in accordance with instructions from appropriate control software.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method of threat assessment, comprising:
receiving data representative of a plurality of safety assessment categories and a plurality of threats within said plurality of safety assessment categories;
receiving data representative of at least one safety measure related to each of said plurality of threats;
analyzing said data with a safety assessment algorithm; and
outputting a safety assessment scorecard indicating safety and security level of a facility.

2. The method of claim 1, including selecting said plurality of safety assessment categories from a group consisting of facility exterior, facility interior, safety protocols, training and combinations thereof.

3. The method of claim 2, including selecting said plurality of threats from a group consisting of exterior ingress/egress, exterior cameras, high speed avenue approach, light line, lobby/reception area, interior ingress/egress, interior cameras, VIP offices, offices, utility rooms, open room, employee identification, policy and procedure, reporting, mass communication and combinations thereof.

4. The method of claim 3, including selecting said at least one safety measure related to the exterior ingress/egress from a group consisting of number of ingress points, location of ingress points, exterior ingress/egress access control, presence of solid core doors, presence of glass in the doors, visibility of restriction for exterior ingress/egress access control from outside and combinations thereof.

5. The method of claim 3, including selecting said at least one safety measure related to the exterior cameras from a group consisting of live monitoring of exterior cameras, off-site live monitoring of exterior cameras, camera range to furthest active point, low light capabilities and combinations thereof.

6. The method of claim 3, including selecting said at least one safety measure related to a high speed avenue of approach from a group consisting of installed bollards, installed speed bumps, presence of structure barriers, presence of pedestrian barriers and combinations thereof.

7. The method of claim 3, wherein said at least one safety measure related to the light line is lighting extending beyond buildings on all sides by a predetermined distance.

8. The method of claim 3, including selecting said at least one safety measure related to the lobby/reception area from a group consisting of installed hot box protocols, personnel present at lobby/reception desk, quick-lock protocols and combinations thereof.

9. The method of claim 3, wherein said at least one safety measure related to the interior ingress/egress consists of interior ingress/egress access control, stop gaps and visibility of restriction for interior ingress/egress control from outside.

10. The method of claim 3, including selecting said at least one safety measure related to the interior cameras from a group consisting of live monitoring of said interior cameras, including those located at ingress/egress points, off-site monitoring, utilizing an interior camera mirror layout and combinations thereof.

11. The method of claim 3, wherein said at least one safety measure related to the VIP offices includes a two-tier security level.

12. The method of claim 3, wherein said at least one safety measure related to the offices includes access control to said offices, stop gaps, interior visual restrictions and solid core doors with minimal glass.

13. The method of claim 3, wherein said at least one safety measure related to the utility rooms includes access control to said utility rooms.

14. The method of claim 3, wherein said at least one safety measure related to the open room includes interior camera protocols for a mirror layout.

15. The method of claim 3, including selecting said at least one safety measure related to said employee identification from a group consisting of access control keycard, picture ID, two-sided ID, color coded ID and combinations thereof.

16. The method of claim 3, including selecting said at least one safety measure related to the policy and procedure from a group consisting of annual review process or incident review, termination/disciplinary meeting protocols, emergency planning and combinations thereof.

17. The method of claim 3, wherein said at least one safety measure related to the reporting, including threat reporting, after-action reporting, incident reporting and training reporting, is analysis driven.

18. The method of claim 3, including selecting said at least one safety measure related to the mass communication from a group consisting of notification capabilities, GEO locator capability upon activation and combinations thereof.

19. The method of claim 3, including earning extra credit on said scorecard for a factor selected from group consisting of perimeter control, unarmed security, armed security, visitor identification, metal detector, mass lock/unlock capability, 24/7 camera monitoring, 24/7 roaming patrol, trained safety team, checkpoints, cyber security and combinations thereof.

20. The method of claim 3, further including limiting establishment of any safety measure to an individual having a minimum of 20 years of law enforcement and/or military training or experience.
